(19) United States
(12) Patent Application Publication
(10) Pub. No.: US 2026/0117693 A1
(43) Pub. Date: Apr. 30, 2026

(54) Supply Module Housing for a Vehicle, Supply Module for a Vehicle, and Vehicle

(71) Applicant: ZF Friedrichshafen AG, Friedrichshafen (DE)

(72) Inventors: Axel Rohm, Schonungen (DE); Tobias Höche, Hallstadt (DE); Joel Kring, Hayingen-Anhausen (DE)

(21) Appl. No.: 19/121,013

(22) PCT Filed: Sep. 12, 2023
(86) PCT No.: PCT/EP2023/074944

§ 371 Date: Apr. 14, 2025

(30) Foreign Application Priority Data
Oct. 14, 2022 (DE) 10 2022 210 905.8

(51) Int. Cl. F01P 5/10; B60K 11/02; F01P 7/14; F01P 11/04

(52) U.S. Cl. CPC F01P 5/10; B60K 11/02; F01P 7/14; F01P 11/04; F01P 2007/146

(57) ABSTRACT

A supply module for a vehicle includes a pump housing for accommodating at least one coolant pump. The supply module further includes valve housings, each configured to accommodate at least one valve, with the pump housing and the valve housings being spaced apart along an arrangement direction. Moreover, the supply module includes intermediate channels, each being defined between respective adjacent ones of the pump and valve housings. Additionally, the supply module includes at least one connection unit. Each of the pump housing, the valve housings, and the intermediate channels has coolant interfaces on at least one first interface side which are fluidically connectable to coolant lines of a unit to be supplied with coolant. Each of the at least one connection unit fluidically connects one of the coolant interfaces of one of the valve housings to a respective one of the coolant interfaces of one of the intermediate channels.

### CROSS-REFERENCE TO RELATED APPLICATION

The present application is related and has right of priority to German Patent Application No. 10 2022 210 905.8 filed on Oct. 14, 2022 and is a nationalization of PCT/EP2023/074944 filed in the European Patent Office on Sep. 12, 2023, both of which are incorporated by reference in their entirety for all purposes.

### FIELD OF THE INVENTION

The invention relates generally to a supply module housing for a vehicle and to a supply module having such a supply module housing, and to a vehicle, in particular an electric vehicle.

### BACKGROUND

Electric vehicles require a cooling system in order to dissipate the power losses that arise in the units such as the battery, the electric machine, the reduction gear unit, the bearings, etc., and electronic components such as inverters, DC/DC converters, DC-AC converters, etc., in particular during operation and during the charging of the battery.

The vehicle systems usually have multiple cooling circuits, which can be partly coupled to one another in order to form a thermal management system. In general, a coolant circuit having a water-glycol coolant is present, via which the heat loss is dissipated to the surroundings. A further coolant circuit includes a heat pump/air-conditioning system for air conditioning the passenger compartment and/or for assisting in the dissipation of heat from the components. A third coolant circuit is provided in many systems for dissipating heat from the lube oil-and cooling oil-system of the transmission. In order to control the heat flows in an open loop, devices are required, which direct the coolant flows and fluid flows in different directions or assign the coolant flows and fluid flows to different circuits.

Magnetically actuated 2/3-way valves, or 2/4-way valves, or 3/4-way valves are typical, which valves are interconnected in different combinations in order to form the intended coolant circuits.

Drives, in particular electrical propulsion units, require an intelligent distribution of energy in order to efficiently utilize the available battery capacity. A thermal management system is useful for this purpose, which system ensures that the energy is distributed in accordance with the requirements by supplying thermally managed coolant to the components according to demand in order to either heat or cool these components.

Multiple centrifugal pumps are usually arranged in the coolant circuits in order to circulate the coolant. The coolant circuits can be interconnected by the combination of individual valves or by a rotary valve system. Both require a correspondingly large amount of installation space and/or a great deal of installation effort to connect the wire harnesses of the coolant circuit.

### SUMMARY OF THE INVENTION

One problem addressed by the present invention is that of providing a supply module housing for a vehicle, a supply module for a vehicle, and a vehicle, in particular an electric vehicle, which solves and/or at least improves one or more of the aforementioned disadvantage(s). In particular, one problem addressed by the present invention is that of providing a supply module housing for a vehicle, a supply module, and a vehicle, in particular an electric vehicle, which provide a supply module housing, or a supply module including such a supply module housing, which supply module housing is space-saving and has been adapted to the individual needs of a particular coolant circuit.

The problem is solved according to a first aspect by a supply module housing for a vehicle, including a pump housing for accommodating at least one coolant pump and at least two valve housings for accommodating one valve each, wherein the pump housing and the valve housings are arranged along an arrangement direction at a distance from each other and the supply module housing further includes an intermediate channel in each case between the spaced-apart pump housing and valve housings, which intermediate channel conducts coolant. The pump housing, the valve housings, and the intermediate channels each have a plurality of coolant interfaces on at least one first interface side of the supply module housing, in particular of the pump housing, of the intermediate channels, and of the valve housings, which coolant interfaces are fluidically connectable to coolant lines of at least one unit to be supplied with coolant. The supply module housing further includes at least one connection unit, which fluidically connects a coolant interface of one of the valve housings to a coolant interface of one of the intermediate channels. The at least one connection unit is at the coolant interface of the one of the valve housings and of the coolant interface of the one intermediate channel.

Using the supply module housing according to the invention, at least one coolant pump and at least two valves are accommodated in a particularly compact manner. The pump housings and the valve housings already include the coolant interfaces. In addition, by the at least one connection unit, in particular by a plurality of connection units and the associated connection between a coolant interface of a valve housing and a coolant interface of an intermediate channel, a corresponding coolant circuit can be made possible, which can be individually adapted to the needs of a coolant circuit which is connected and is to be activated. By the at least one connection unit, in particular by two, three or more connection units, a supply module housing can be simple and compact, which supply module housing is easy to install and already includes a required interconnection of the coolant interfaces. Space and installation effort can therefore be reduced.

The supply module housing can be formed in one piece with the pump housing and the valve housings and with the intermediate channels. Alternatively, or additionally, the supply module housing can be formed in one piece with the pump housing and the valve housings, the intermediate channels, and at least one of the at least one connection unit, at least one closing unit described in the following, at least one pump connection unit described in the following, and at least one connection unit plate described in the following.

The supply module housing and/or individual elements of the supply module housing can consist of and/or be made of at least one of plastic, aluminum, steel, and magnesium.

The pump housing, the valve housing, the intermediate channels, the plurality of coolant interfaces, the at least one connection unit, and/or the at least one pump connection unit can conduct coolant. In particular, the plurality of coolant interfaces can be designed such that each coolant interface provides a fluidic connection to an internal volume of the pump housing, of the particular valve housing, and/or of the particular intermediate channel. The coolant pump can pump coolant.

The pump housing may accommodate at least two, three or more, in particular two, coolant pumps. The pump housing may accommodate at least one drive for the at least one coolant pump, in particular two or more, advantageously three, coolant pumps. The pump housing may accommodate a number of coolant pumps on the basis of a number of coolant circuits, wherein in particular the number of coolant circuits and the number of coolant pumps can be equal. The at least one coolant pump can be a circulation pump.

The supply module housing can include three or more valve housings. The at least two valve housings conduct coolant. The accommodatable valves can be axial slide valves.

A number of valve housings and/or the plurality of coolant interfaces can be determined on the basis of coolant requirements of the at least one unit to be supplied with coolant.

The pump housing can include one coolant interface of the plurality of coolant interfaces, which coolant interface forms a coolant outlet on the pump housing.

The pump housing and the valve housings can be arranged along the arrangement direction at a distance from each other with a predetermined pitch or spacing therebetween. Alternatively, or additionally, the pump housings and the valve housings can be spaced apart from each other with different pitches therebetween. The pitch between the pump housing and one of the valve housings and/or the pitch between the two valve housings can be equal or different. In particular, the particular pitch can be determined on the basis of the particular intermediate channel arranged between the pump housing and the valve housing and/or the particular intermediate channel arranged between the valve housings. The pitch can be determined on the basis of a diameter of the particular intermediate channel. The diameter can extend parallel to the arrangement direction. A dimensioning of the pump housing, of the valve housings, of the intermediate channels, and/or of the plurality of coolant interfaces can be determined on the basis of the requirements of the at least one unit to be supplied with coolant. The at least one unit to be supplied with coolant can be an element of a thermal management system, such as an evaporator, and/or a condenser, and/or an element in the vehicle, such as a passenger compartment, in particular at least one passenger compartment heat exchanger, a battery, and a drive, in particular an electrical propulsion unit.

Alternatively, or additionally, the supply module housing can be designed such that the intermediate channel between the pump housing and the adjacent valve housing and/or the intermediate channel between valve housings adjoin one another at least in sections. These can adjoin one another at least in sections such that the particular fluid flows through the particular housings or intermediate channels are separated. Therefore, the pump housing, the valve housings, and the intermediate channels can be fluidically separated from one another. A fluidic connection can be established by connecting the appropriate coolant interfaces.

The intermediate channels can be designed as a line (e.g., linear) or can include a line. The intermediate channels can conduct coolant.

The intermediate channels, the pump housing, the valve housings, and/or the at least one connecting element can be pressure-resistant.

The plurality of coolant interfaces can include two, three, four, five or more coolant interfaces. The pump housing can include, in particular, two coolant interfaces. The intermediate channel between the pump housing and the one valve housing can include, in particular, three coolant interfaces. The intermediate channel between the valve housings can include, in particular, two or three coolant interfaces. The intermediate channel between the pump housing and the one valve housing can advantageously include three coolant connections. The intermediate channel or intermediate channels between the valve housings can include two or three coolant interfaces. The valve housing can include, in particular, four or five coolant interfaces. Advantageously, a first valve housing of the valve housings can include five coolant interfaces and a second valve housing of the valve housings can include four coolant interfaces. When there are three valve housings, the first valve housing of the valve housings can include five coolant interfaces, the second valve housing of the valve housings can include four coolant interfaces, and a third valve housing can include five coolant interfaces, which second valve housing is arranged along the arrangement direction between the first valve housing and the third valve housing.

The coolant interfaces can be raised areas on an outer side of the pump housing, of the intermediate channels, and/or of the valve housings. The raised areas can extend away from the at least one first interface side. The coolant interfaces can be passage openings into the interior of the pump housing, of the intermediate channels, and/or of the valve housings. This can be advantageous in the production of the supply module housing, since the supply module housing can be an aluminum profile and/or an extruded profile.

The supply module housing can include two, three or more connection units. A number of the connection units can be determined on the basis of the requirements of the coolant interface(s) to be connected and/or coolant circuit(s).

The at least one connection unit can be pressure-resistant. The at least one connection unit can be a pipe and/or a line for fluidically conducting coolant.

The at least one connection unit and/or the coolant interfaces can be designed such that the at least one connection unit is connectable and/or coupleable to the coolant interfaces and/or the coolant interfaces are connectable and/or coupleable to coolant lines. In particular, these can be quick-coupleable and/or flangeable.

The pump housing and/or the valve housings can receive the coolant pump and the valves from a receiving side of the supply module housing, in particular along a receiving direction. Correspondingly, the valves and/or the coolant pump can be aligned in parallel with one another. The intermediate channels can extend substantially along the receiving direction. The receiving side can be a side of the supply module housing which differs from the first interface side and/or any other interface side. In particular, the receiving side can be oriented perpendicular to the first interface side and/or to any other interface side.

The at least one connection unit can be arranged such that the connection unit fluidically connects the coolant interface of one of the valve housings to the coolant interface of one of the intermediate channels on the basis of a requirement, in particular a connection requirement of the coolant lines and/or at least one coolant circuit of the coolant lines.

The supply module housing can also include at least one closing unit, which closes a coolant interface of the pump housing, of one of the valve housings, or of one of the intermediate channels, in particular according to the connection requirement. Therefore, predetermined coolant interfaces of the plurality of coolant interfaces can be “dead-ended” coolant interfaces. The supply module housing can include the at least one closing unit on one of the first interface side and a second interface side.

The pump housing and/or the valve housings can receive the coolant pump and/or the valves along the receiving direction, which extends perpendicularly to the arrangement direction.

The valve housings can be arranged such that the valves are receivable along the receiving direction such that the received valves, in particular the axial slide valves, are oriented in parallel with the receiving direction.

The pump housing can be arranged along the arrangement direction ahead of, between, or after the at least two valve housings.

The supply module housing, in particular the pump housing, the valve housings, and the intermediate channels, can extend from the first interface side along a coupling direction, which extends perpendicularly to the arrangement direction and the receiving direction, to a second interface side, wherein the supply module housing, in particular the pump housing, the valve housings, and/or the intermediate channels, each have a plurality of coolant interfaces on the second interface side of the supply module housing, in particular of the pump housing, of the valve housings, and/or of the intermediate channels, which are fluidically connectable to coolant lines of at least one or the unit to be supplied with coolant.

The supply module housing can include, alternatively or additionally to the at least one connection unit, at least one further connection unit, which fluidically connects a coolant interface on the second interface side of one of the valve housings to a coolant interface of one of the intermediate channels on the second interface side. Therefore, the at least one connection unit fluidically connects the coolant interface on the first interface side of one of the valve housings to the coolant interface on the first interface side of one of the intermediate channels.

At least in part, the plurality of coolant interfaces on the first interface side and the plurality of coolant interfaces on the second interface side can be positioned opposite one another. Features relating to the plurality of coolant interfaces on the first interface side relate to the plurality of coolant interfaces on the second interface side. In addition, features associated with the plurality of coolant interfaces, such as the at least one connection unit and the at least one closing unit, can also be at least one connection unit and at least one connection unit for the plurality of coolant interfaces on the second interface side. Correspondingly, the plurality of coolant interfaces on the second interface side can extend away from the second interface side. The plurality of coolant interfaces on the first and/or the second interface side(s) can extend substantially along the coupling direction. Due to coolant interfaces being positioned opposite one another on the two interface sides, the coolant interfaces can be easily formed by through-holes from the first interface side to the second interface side, or vice versa.

The pump housing and/or the valve housings can have openings for receiving the coolant pump and/or the valves, which openings are cylindrical, which cylindrical openings extend along the receiving direction and have a cylinder base, which is perpendicular to the receiving direction. The pump housing and/or the valve housings can have, at least in part, a cylindrical shape, which at least partially replicates the cylindrical shape of the openings. For this purpose, the pump housings and/or the valve housings can have a wall thickness, at least in sections, which results from a difference between the inner diameter and the outer diameter of the particular housing. The wall thickness can be determined on the basis of the requirements on an inner pressure of a coolant in the pump housings and/or valve housings.

The at least one connection unit can be arranged such that the at least one connection unit fluidically connects the coolant interface of the one valve housing to the coolant interface of one of the intermediate channels of the intermediate channels, which is adjacent to the one valve housing as viewed along the arrangement direction. The invention therefore relates to a particularly short connection unit, which keeps a material requirement, a weight, and a coolant volume required for the internal volume of the connection unit low.

The at least one connection unit can be at least partially, in particularly completely, arcuate.

At least one coolant interface, in particular on the second interface side of one of the intermediate channels, which is arranged between the pump housing and the valve housing, can be connectable to a compensation unit in order to enable a compensation of coolant pressure and/or volume. For this purpose, the coolant interface can include an orifice. The compensation unit can output coolant to the coolant interface and/or to receive coolant from the coolant interface. The compensation unit can also regulate a fluid pressure of the coolant. The compensation unit can be an expansion tank with coolant and/or a reservoir with coolant.

The supply module housing can also include at least one pump connection unit, which fluidically connects a coolant interface of the pump housing to a coolant interface of one of the intermediate channels, in particular of the intermediate channel which is arranged between the pump housing and the valve housing, and/or a coolant interface of one of the valve housings, in particular of the valve housing adjacent to the pump housing as viewed along the arrangement direction.

The at least one pump connection unit can also be fluidically connect the coolant interface of the pump housing, the coolant interface of the intermediate channel, and/or the coolant interface of the valve housing to a coolant inflow, in particular a coolant reservoir. The supply module housing can include two, three or more pump connection units. A number of pump connection units can be determined on the basis of a number of coolant circuits and/or a number of coolant pumps and, in particular, can be identical to this or these. Therefore, when there are two coolant circuits, two pump connection units can be present. The at least one pump connection unit can be a pipe and/or a line. The at least one pump connection unit can be pressure-resistant and/or conduct coolant. The supply module housing can include the at least one pump connection unit at least on one of the two interface sides. The at least one pump connection unit can conduct coolant. The at least one pump connection unit can include a plurality of coolant interfaces, in particular two or more coolant interfaces, which are connectable to the coolant interfaces of the intermediate channels, of the pump housing, and/or of the valve housings.

The supply module housing can also include at least one first connection unit plate, which extends in particular substantially in parallel with the arrangement direction and the receiving direction, wherein the at least one connection unit is arranged on and/or at least partially in the connection unit plate and/or the connection unit plate and the at least one connection unit are formed in one piece. The connection plate can be arranged and/or designed to be arrangeable, connectable, and/or coupleable on the first interface side for connecting the coolant interfaces by the at least one connection unit. The at least one first connection plate can be designed such that the at least one connection unit is arranged on the underside of the first connection plate, which faces the first interface side.

The supply module housing can include, alternatively or additionally, a second connection unit plate, which extends in particular substantially in parallel with the arrangement direction and the receiving direction, wherein at least one further connection unit is arranged on and/or at least partially in the second connection unit plate and/or the second connection unit plate and the at least one further connection unit are formed in one piece. The connection unit plate can be arranged and/or designed to be arrangeable, connectable, and/or coupleable on the first interface side for connecting the coolant interfaces by the at least one connection unit. The second connection unit plate can be designed such that the at least one connection unit is arranged on the top side of the second connection plate, which faces the second interface side.

The first and/or the second connection unit plate(s) can be formed in one piece with the particular at least one connection unit. The first and/or the second connection unit plate(s) can have a thickness which extends along the coupling direction.

The first and/or the second connection unit plate(s) can also include the at least one closing unit and/or the at least one closing unit can be arranged on the particular connection plate. The first and/or the second connection plate(s) can be formed in one piece with the at least one closing unit and/or the at least one connection unit.

The supply module housing can include a pump opening cover and/or at least one valve opening cover for closing the pump opening and/or the particular valve opening.

The problem is solved according to a second aspect by a supply module for conducting coolant for a vehicle, including a supply module housing according to the first aspect, at least one coolant pump received in the pump housing; at least two valves received in the valve openings, which coolant pump pumps coolant, and which valves adjust a coolant flow between the coolant interfaces on the basis of a valve position of the valve.

Features of the supply module housing according to the first aspect can be features of the supply module according to the second aspect. Features of the supply module according to the second aspect can be features of the supply module housing according to the first aspect.

The supply module can include two or more coolant pumps, which are received in the pump housing. In particular, two or more coolant pumps can be accommodated when there are two or more coolant circuits. Therefore, a first coolant pump of the two coolant pumps can pump a coolant in a first coolant circuit and a second coolant pump of the two coolant pumps can pump a coolant in a second coolant circuit.

The supply module can also include a drive in the pump housing, which drives the at least one coolant pump. Therefore, the pump housing accommodates the drive. When there are two or more coolant pumps, the drive can drive the two or more coolant pumps.

When there are two coolant pumps and two coolant circuits, the at least one connection unit and/or any further connection unit can be an interface between the two coolant circuits. In particular, these can be designed such that no thermally relevant crossflows are permitted.

The pump housing, the at least two valve housings, and/or the intermediate channels can have the cylindrical openings and be arranged along the arrangement direction such that a particular central axis of the cylindrical openings, which extends perpendicularly to the cylinder base and, in particular, through a center of the cylinder base, extends in parallel with the arrangement direction. In particular, the central axes of the cylindrical opening extend in parallel with the arrangement direction and within a plane which extends through the arrangement direction and the receiving direction.

The intermediate channels can have an internal volume which is smaller than an internal volume of the pump housing and/or of the at least two valve housings.

The internal volumes of the pump housing and/or of the at least two valve housings can be at least partially identical and/or different. In addition, an inner diameter of the intermediate channels can be smaller than an inner diameter of the pump housing and/or of the at least two valve housings, wherein the inner diameter extends along the arrangement direction or the coupling direction.

At least one of the valves can include an actuator for driving the valve. The actuator can close the valve housing.

The pump housing, the valve housings, and the intermediate channels can be fluidically separated from one another. In particular, the pump housing, the valve housings, and/or the intermediate channels can be fluidically connected via the particular coolant interfaces, advantageously in order to conduct coolant and/or to form coolant circuits.

The problem is solved according to a third aspect by a vehicle, in particular an electric vehicle, including a supply module housing according to the first aspect and/or a supply module according to the second aspect. The vehicle, in particular the electric vehicle, can include an electrical propulsion unit.

### BRIEF DESCRIPTION OF THE DRAWINGS

Preferred exemplary embodiments are explained by way of example on the basis of the accompanying figures. Wherein:

FIG. 1 shows a perspective view of a first exemplary embodiment of a supply module including a supply module housing;

FIG. 2 shows a first cross-section of the supply module;

FIG. 3 shows a second cross-section of the supply module;

FIG. 4 shows a third cross-section of the supply module; and

FIG. 5 shows a vehicle including the supply module.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

In the figures, identical or substantially functionally identical or functionally similar elements are labeled with identical reference characters.

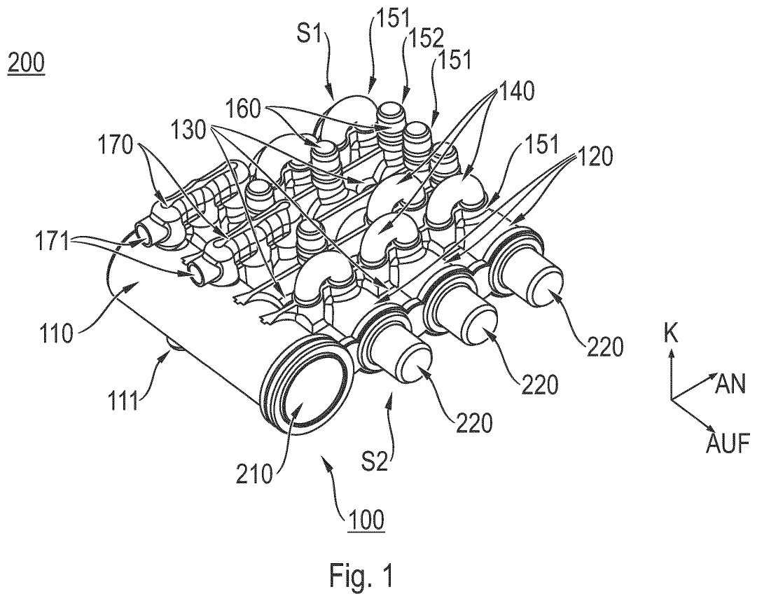

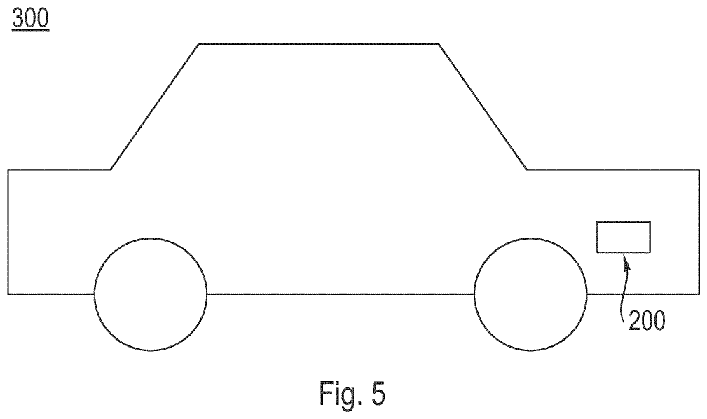

FIG. 1 shows a supply module 200 for a vehicle 300 (FIG. 5), the supply module including a supply module housing 100. The supply module housing 100 includes a pump housing 110 and at least two, in FIG. 1 three, valve housings 120. The pump housing 110 and the valve housings 120 are arranged along an arrangement direction AN at a distance from each other.

According to FIG. 1, the pump housing 110 and the valve housings 120 are separated by a predetermined pitch therebetween as viewed along the arrangement direction AN. According to FIG. 1, the pitch between the pump housing 110 and the valve housings 120 is uniform, although the pitch can be different at least in parts. Intermediate channels 130 are arranged in the spaces between the pump housing 110 and the valve housings 120. Therefore, the pitch between the pump housing 110 and the valve housings 120 is determined on the basis of the intermediate channels 130, in particular on the basis of an inner diameter of these intermediate channels.

According to FIGS. 1 through 4, the pump housing 110 and the valve housings 120 have cylindrical openings. The intermediate channels are cylindrical. A particular cylinder base extends within a plane which extends through the arrangement direction AN and a coupling direction K, which extends perpendicularly to the arrangement direction AN. A particular cylinder height extends along a receiving direction AUF, which extends perpendicularly to the arrangement direction AN and the coupling direction K. Central axes of the pump housing 110, of the valve housings 120, and of the intermediate channels 130 extend along the receiving direction AUF and extend within a plane which extends through the receiving direction AUF and the arrangement direction AN. The central axes therefore extend in parallel with one another. In other words, the central axes lie within a common plane.

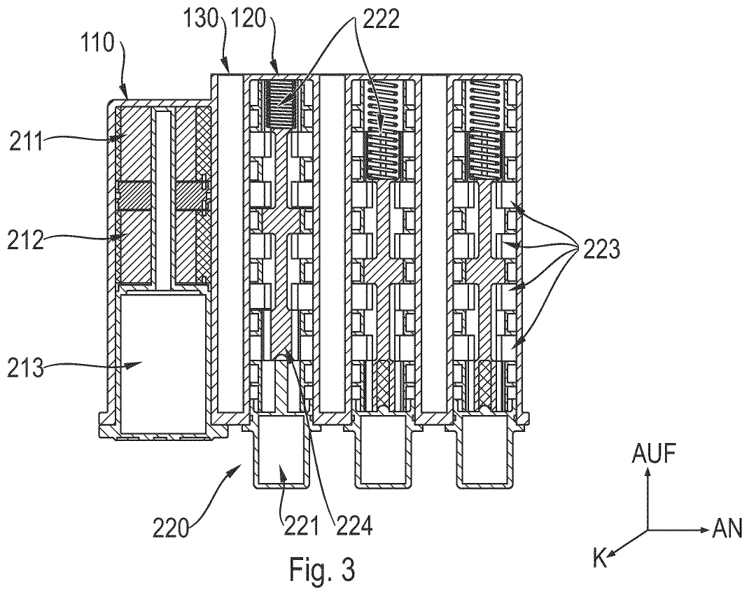

According to FIGS. 1 through 4, the pump housing 110 and the valve housings 120 have the particular cylindrical openings in order to receive, from a receiving side, at least one coolant pump 210 and three valves 220 in the particular, respective openings. If there are two or more coolant circuits, two or more coolant pumps 211, 212 (FIG. 3) are receivable in the pump housing 110. According to FIG. 1, the receiving side faces the viewer. On a side opposite the receiving side, the openings are closed. The openings are therefore not passage openings. This has the advantage, in particular, that, as viewed along the receiving direction AUF, the openings need to be closed only on the receiving side in order to prevent a discharge of fluid from the opening along the receiving direction AUF. The coolant pump 210 and the valves 220 are included in the supply module 200.

The supply module housing 100 also includes at least one, according to FIG. 1 six, connection units 140, which are arcuate. The pump housing 110, the valve housings 120, and the intermediate channels 130 each have a plurality of coolant interfaces 151, 152 on a first interface side S1, which are connectable to coolant lines of at least one unit to be supplied with coolant. The at least one unit to be supplied with coolant is a unit of a thermal management system in the vehicle 300, such as a heat pump, for example, a condenser, or is a unit in the vehicle 300, such as a heat exchanger of a passenger compartment, a battery, a radiator, or a motor.

A vehicle includes multiple coolant circuits which require an appropriate combination of coolant interfaces and valves in order to be able to operate and/or connect the coolant circuits according to the requirements of the vehicle. In addition, depending on the vehicle, the coolant circuits are designed differently, such that a great deal of effort is required to arrange individual valves and corresponding coolant pumps. According to FIG. 1, the invention therefore relates to a supply module 200 in which the coolant pump 210 and the valves 220 are accommodated in the supply module housing 100 in a simple and space-saving manner. In addition, the pump housing 110, the valve housings 120, and the intermediate channels 130 each have a plurality of coolant interfaces 151, 152. Depending on the requirement, the coolant interfaces 151, 152 are connectable by the connection units 140 in order to connect appropriate coolant circuits by the valves 220. In addition, coolant interfaces 151, 152 that are not required are closable by closing units 160.

According to FIG. 1, the supply module housing 100 also includes two pump connection units 170, each of which fluidically connects internal coolant interfaces 151 of an intermediate channel 130, which is arranged between the pump housing 110 and the adjacent valve housing 120, and of the adjacent valve housing 120 to the pump housing 110. In addition, the pump connection units 170 each have a connection 171 to a coolant reservoir and/or refrigerant reservoir.

According to FIG. 1, the supply module housing 100 extends from the first interface side S1 along the coupling direction K to a second interface side S2, which supply module housing 100 includes coolant interfaces 151, 152 on the first and the second interface sides S1, S2. As shown in FIG. 1, the coolant interfaces 151, 152 on the first interface side S1 are used to achieve an appropriate interconnection of the coolant interfaces 151, 152 by the connection units 140, the closing units 160, and the pump connection units 170. The interconnection is carried out on the basis of a connection requirement of the coolant lines and/or of at least one coolant circuit of the coolant lines, in particular in the vehicle 300 (FIG. 5).

The coolant interfaces 151, 152 on the second interface side S2 is easily connectable to coolant lines of the coolant circuits in the vehicle 300 (FIG. 5).

Alternatively, or additionally, connection units 140, closing units 160, and pump connection units 170 are also provided on the second interface side S2. In particular, the coolant interfaces 151, 152 on the first and the second interface sides S1, S2 are arranged opposite one another, at least in part, as viewed along the coupling direction K. This has advantages in the production of the supply module housing 100, since the coolant interfaces 151, 152 are formed on the two interface sides S1, S2 by through-holes.

The connection units 140 are arcuate and pressure-resistant and conduct coolant from one coolant interface 151, 152 to the other connected coolant interface 151, 152.

The coolant interfaces 151, 152 are designed, in particular, such that a connection to the connection units 140, to the closing units 150, to the pump connection units 170, and/or to the coolant lines is/are established without the use of tools, for example, by a quick coupling. In particular, the coolant interfaces 151, 152 make a liquid-tight connection possible.

FIG. 1 also shows a pump outlet 111 of the pump housing for a coolant discharge. FIG. 1 also shows that a connection unit 140 in each case fluidically connects a coolant interface 151, 152 of a valve housing 120 to a coolant interface 151, 152 of an intermediate channel 130 adjacent to the valve housing 120.

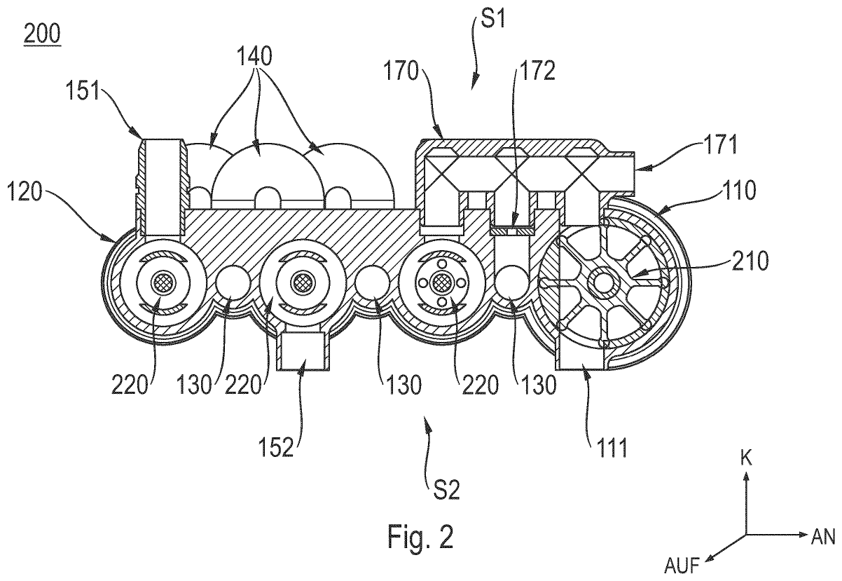

FIG. 2 shows a first cross-section of the supply module 100 according to FIG. 1 as viewed along the arrangement direction AN and the coupling direction K. The external coolant interfaces 152 are connectable to coolant lines which conduct coolant to and from the at least one unit in the vehicle 300 (FIG. 5) to be supplied with coolant. The internal coolant interfaces 151 provide a coolant connection and/or a coolant interface between the valve housings 120, in particular the valves 220 that are advantageously axial slide valves, and/or the pump housing 110, in particular the coolant pump 210, in order to enable the necessary functions and/or interconnections. Depending on the application and/or need, the internal coolant interfaces are connectable to the connection units 140 such as pipes and/or hoses, dead-ended, closed, and/or are omitted.

The at least one coolant pump 210, the coolant pump 211 (FIG. 3), and/or the coolant pump 212 (FIG. 3) is a circulation pump. As is apparent from FIGS. 1 through 4, the valves 220, in particular the axial slide valves 220, are arranged in parallel with the coolant pump 210 or the coolant pumps 211, 212 (FIG. 3). The supply module housing 100 is formed in one piece with the pump housing 110, the valve housings 120, and the intermediate channels 130.

According to FIG. 2, an orifice 172 is arranged between the intermediate channel 130, which is arranged between the pump housing 110 and the adjacent valve housing 120, and the pump connection unit 170 on an external coolant interface 152 of the adjacent intermediate channel 130. A pressure and/or volume compensation is carried out via this orifice. The pump connection unit 170 also includes a connection 171 for a compensation unit. The compensation unit is an expansion tank with coolant and/or a coolant reservoir with coolant.

FIG. 3 shows a second cross-section of the supply module 200 along the receiving direction AUF and the arrangement direction AN. According to FIG. 3, the supply module 200 has two coolant pumps 211, 212. The coolant pumps 211, 212 are driven by a common drive 213. The drive 213 drives the two coolant pumps 211, 212 via a common shaft.

In principle, it is possible to establish different flow rates in the two coolant circuits in that the coolant pumps 211, 212 have different sizes and/or efficiencies. The ratio remains the same at all rotational speeds due to the geometric conditions, wherein, depending on the pump type, the delivery rate is limited to a greater or lesser extent by the total resistance in the coolant circuit. In an embodiment of the coolant pumps 210, 211, 212 as centrifugal pumps, it is therefore useful to define the flow rate ratios between the coolant circuits by hydraulic balancing by providing orifices (one or more orifices) in the coolant circuits. Alternatively, the coolant pumps 210, 211, 212 are displacement pumps, in particular vane-cell pumps or impeller pumps. In these pumps, the delivery rate is nearly proportional to the rotational speed, so that different resistances in the coolant circuits only lead to corresponding pressure level differences in the coolant circuits. In order to avoid this, a hydraulic balancing is adjustable and/or provided. In addition, in particular when a coolant circuit system including two or more coolant circuits is to be operated with only one single expansion vessel, a connection is between the coolant circuits for pressure compensation, wherein the connection is configured such that the cross-sections do not permit thermally relevant crossflows between the two coolant circuits.

The valves 220 are axial slide valves and each have an actuator 221 on the receiving side, a spring 222 on a side opposite the actuator 221, and a valve spool 224 arranged between the actuator 221 and the spring 222. As is also shown in FIG. 3, the valves 220 have a plurality of annular channels 223, which are arranged such that a fluid connection with the coolant interfaces 151, 152 of the valve housings 120 is established.

In addition, the valves 220 have cavities at the two ends of the valve spool 224, which cavities are fillable with liquid in order to dampen the valve spool 224 when the valve spool 224 is moved and during compression or expansion.

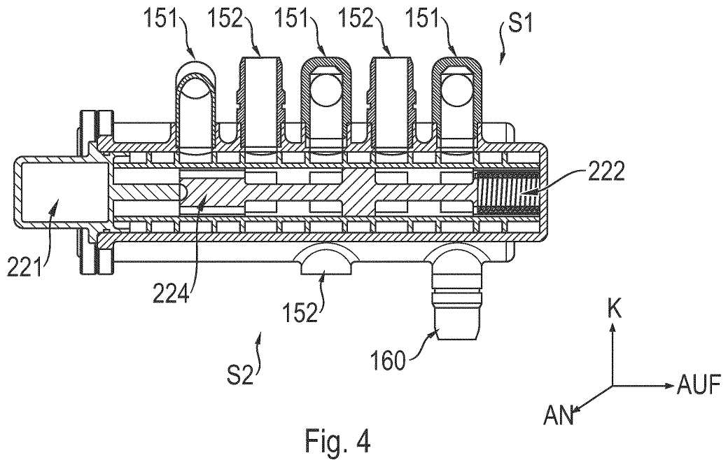

FIG. 4 shows a third cross-section of the supply module 100 including an accommodated valve 220 along the coupling direction K and the receiving direction AUF. On the second interface side S2, the supply module 100 has an external coolant interface 152 for connection to a heat exchanger of a heat pump.

The pump housing 110, the valve housings 120, the intermediate channels 130, the plurality of coolant connections 151, 152, and/or the connection units 140 conduct coolant in order to form one or more coolant circuits, in particular with connected coolant lines in the vehicle 300 (FIG. 5).

The supply module housing 100 includes at least one connection unit plate, which extends substantially parallel to the arrangement direction AN and the receiving direction AUF, the at least one connection unit 140 being arranged on the connection unit plate, and/or the connection unit plate and the at least one connection unit are formed in one piece. The connection plate is arrangeable on the first interface side S1 for connecting the coolant interfaces 151, 152 by the at least one connection unit.

FIG. 5 shows the vehicle 300 including the supply module 200. Alternatively, or additionally, the vehicle 300 includes the supply module housing 100.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

100 supply module housing
110 pump housing
111 pump outlet
120 valve housing
130 intermediate channels
140 connection unit
151 internal coolant interface
152 external coolant interface
160 closing unit
170 pump connection unit
171 coolant reservoir connection
172 orifice
200 supply module
210 coolant pump
211 first coolant pump
212 second coolant pump
213 drive
220 valve
221 actuator
222 spring
223 annular channel
224 valve spool
300 vehicle

1-15. canceled

16. A supply module housing (100) for a vehicle (300), the supply module housing (100) comprising:
a pump housing (110) for accommodating at least one coolant pump (210);
at least two valve housings (120), each of the at least two valve housings (120) being configured to accommodate at least one valve (220), the pump housing (110) and the at least two valve housings (120) being spaced apart from each other along an arrangement direction (AN);
a plurality of intermediate channels (130) for conducting coolant, each of the plurality of intermediate channels (130) being defined between respective adjacent ones of the pump housing and the at least two valve housings (110, 120); and
at least one connection unit (140),
wherein each of the pump housing (110), the valve housings (120), and the plurality of intermediate channels (130) having a plurality of coolant interfaces (151, 152) on at least one first interface side (S1) of the supply module housing (100), the plurality of coolant interfaces (151, 152) being fluidically connectable to coolant lines of at least one unit to be supplied with coolant, and
wherein each of the at least one connection unit (140) fluidically connects one of the plurality of coolant interfaces (151, 152) of one of the at least two valve housings (120) to a respective one of the plurality of coolant interfaces (151, 152) of one of the plurality of intermediate channels (140).

17. The supply module housing (100) of claim 16, wherein one or both of:
the pump housing (110) being configured to receive the at least one coolant pump (210) from a receiving side of the supply module housing (100); or
each of the at least two valve housings (120) being configured to receive the at least one valve (220) from the receiving side of the supply module housing (100).

18. The supply module housing (100) of claim 16,
wherein each of the at least one connection unit (140) fluidically connects the one of the plurality of coolant interfaces (151, 152) of the one of the at least two valve housings (120) to the respective one of the plurality of coolant interfaces (151,

152) of the one of the plurality of intermediate channels (140) based on a connection requirement of the coolant lines and/or a coolant circuit of the coolant lines.

19. The supply module housing (100) of claim 18, further comprising:
a closing unit (160) closing a coolant interface (151, 152) of the plurality of coolant interfaces (151, 152) of the pump housing (110), of the at least two valve housings (120), or of the plurality of intermediate channels (130) according to the connection requirement.

20. The supply module housing (100) of claim 16, wherein one or both of:
the pump housing (110) being configured to receive the at least one coolant pump (210) along a receiving direction (AUF), the receiving direction (AUF) extending perpendicularly to the arrangement direction (AN); or
each of the at least two valve housings (120) being configured to receive the at least one valve (220) along the receiving direction (AUF).

21. The supply module housing (100) of claim 20,
wherein the pump housing (110), the at least two valve housings (120), and the plurality of intermediate channels (130) extend from the first interface side (S1) to a second interface side (S2) along a coupling direction (K), the coupling direction (K) extending perpendicularly to the arrangement direction (AN) and the receiving direction (AUF),
wherein one or more of the pump housing (110), the at least two valve housings (120), or the plurality of intermediate channels (130) each comprise a further plurality of coolant interfaces (151, 152) on the second interface side (S2), further plurality of coolant interfaces (151, 152) being fluidically connectable to the coolant lines of the at least one unit to be supplied with coolant.

22. The supply module housing (100) of claim 16,
wherein one or both of:
the pump housing (110) defines a cylindrical opening for receiving the at least one coolant pump (210), the cylindrical opening of the pump housing (110) being defined along a receiving direction (AUF), the receiving direction (AUF) extending perpendicularly to the arrangement direction (AN), the cylindrical opening of the pump housing (110) being defined by a base perpendicular to the receiving direction (AUF), or
each of the at least two valve housings (120) defines a cylindrical opening for receiving the at least one valve (220), the cylindrical openings of the at least two valve housings (120) being defined along the receiving direction (AUF), the cylindrical openings of the at least two valve housings (120) each being defined by a cylinder base perpendicular to the receiving direction (AUF).

23. The supply module housing (100) of claim 16,
wherein each of the at least one connection unit (140) fluidically connects the one of the plurality of coolant interfaces (151, 152) of the one of the at least two valve housings (120) to the respective one of the plurality of coolant interfaces (151, 152) of the one of the plurality of intermediate channels (140) which is adjacent to the one of the at least two valve housings (120) along the arrangement direction (AN).

24. The supply module housing (100) of claim 16,
wherein the at least one connection unit (140) is at least partially arcuate.

25. The supply module housing (100) of claim 16,
wherein at least one coolant interface (151, 152) of a first intermediate channel of the plurality of intermediate channels (130), the first intermediate channel being between the pump housing (110) and an adjacent one of the at least two valve housings (120), is connectable to a compensation unit to enable at least one of a coolant pressure compensation or a volume compensation of the coolant.

26. The supply module housing (100) of claim 25, wherein the at least one coolant interface (151, 152) of the first intermediate channel (130) defines an orifice.

27. The supply module housing (100) of claim 16, further comprising:
at least one pump connection unit (170), each of the at least one pump connection unit (170) fluidically connecting a coolant interface of the plurality of coolant interfaces (151, 152) of the pump housing (110) to a coolant interface of the plurality of coolant interfaces (151, 152) of a first intermediate channel of the plurality of intermediate channels (130) or a coolant interface of the plurality of coolant interfaces (151, 152) of the at least two valve housings (120), the first intermediate channel (130) being between the pump housing (110) and an adjacent valve housing of the at least two valve housings (120).

28. The supply module housing (100) of claim 16, further comprising:
a connection unit plate, the connection unit plate extending substantially in parallel with the arrangement direction (AN) and a receiving direction (AUF), the receiving direction (AUF) extending perpendicularly to the arrangement direction (AN),
wherein the at least one connection unit (140) is arranged on or formed in one piece with the connection unit plate,
wherein the connection unit plate is at the first interface side (S1) for connecting the plurality of coolant interfaces (151, 152) by the at least one connection unit (140).

29. A supply module (200) for conducting coolant for a vehicle (300), the supply module (200) comprising:
the supply module housing (100) claim 16;
at least one coolant pump (210) received in the pump housing (110), the coolant pump (210) being configured to pump coolant; and
at least two valves (220) received in the at least two valve openings (120), each of the at least two valves (220) being configured to adjust a coolant flow between the coolant interfaces (151, 152) based on a valve position.

30. A vehicle (300), comprising the supply module housing (100) of claim 16.
